(19) United States
(12) Patent Application Publication
(10) Pub. No.: US 2006/0151106 A1
(43) Pub. Date: Jul. 13, 2006

(54) Method for producing laminate

(76) Inventors: Katsufumi Hiraishi, Chiba (JP); Katsumi Takata, Chiba (JP); Isamu Takarabe, Chiba (JP)

Correspondence Address: BIRCH STEWART KOLASCH & BIRCH, PO BOX 747, FALLS CHURCH, VA, 22040-0747, US

(21) Appl. No.: 10/559,130

(22) PCT Filed: Jun. 1, 2004
(86) PCT No.: PCT/JP04/07889

§ 371 Date: Dec. 1, 2005

(30) Foreign Application Priority Data
Jun. 2, 2003 (JP) 2003-156342
Jun. 2, 2003 (JP) 2203-156343

(51) Int. Cl. B32B 37/00

(52) U.S. Cl. 156/309.6

(57) ABSTRACT

A laminate is produced from a film of a liquid crystal polymer forming an optically anisotropic molten phase and a metal foil by thermocompression bonding of a pile of the two between pressing rolls and the method comprises using a metal roll coated with a resin such as fluororubber and polyimide to a thickness of 0.02-5 mm as at least one of the pressing rolls or piling a heat-resistant film on the surface of a pile of polymer film and metal foil contacting a metal pressing roll and passing the resulting pile between metal pressing rolls. The method is capable of producing a laminate of good heat resistance from a liquid crystal polymer film and a metal foil with sufficient adhesion between the two at high productivity.

### FIELD OF TECHNOLOGY

This invention relates to a method for producing a laminate from a film of a liquid crystal polymer capable of forming an optically anisotropic molten phase (hereinafter referred to as liquid crystal polymer film).

### BACKGROUND TECHNOLOGY

A liquid crystal polymer film is known as a material with excellent properties in respect to heat resistance, dimensional stability against moisture and high frequency characteristics. With attention focused on these excellent properties inherent in a liquid crystal polymer, film, studies have been in progress on the use of this film as an insulating material in substrates for electronic circuits. In this application, a laminate of a liquid crystal polymer film and a metal foil, typically a copper foil, is suited as a laminate for use in substrates of circuits.

Of the methods known for producing a laminate from a liquid crystal polymer film and a metal foil, thermocompression bonding is practiced by placing a liquid crystal polymer film and a metal foil, respectively cut to a prescribed size and piled one upon another, between the top and bottom plates of a hot press and compressing them in vacuum. However, this is a batch process and faces the problem of inability to produce laminates with uniform product quality, for example, uniform peel strength. Moreover, this method has the shortcomings of low production rate and high cost.

Aiming at lowering the cost and raising the production rate, continuous methods for producing metal-clad laminates have been proposed. For example, a liquid crystal polymer film is piled on a metal foil and they are passed in this condition between pressing rolls such as metal rolls and rubber rolls (JP5-42603A) or a liquid crystal polymer film and a metal foil are bonded by a double belt press (JP8-58024A).

A method shown in JP5-42603A comprises passing a pile of a liquid crystal polymer film on a metal foil between pressing rolls. It is described there that controlling the bonding temperature at a point lower than the melting point of the liquid crystal polymer by 5-80° C. is beneficial to maintaining the mechanical properties and heat resistance inherent in the film and developing strong adhesion between the polymer film and metal foil. Furthermore, it is also described that pressing rolls for bonding a liquid crystal polymer film to a metal foil are available in several types such as 1) metal rolls, 2) rubber rolls and 3) metal rolls coated with rubber or a resin such as polyimide and, preferably, at least one of the pressing rolls is a rubber roll with its hardness controlled in a specified range or a metal roll with a layer of rubber coating.

With the use of the aforementioned 1) metal rolls alone, the pressure cannot be applied uniformly because of the absence of a layer of coating and a laminate with good appearance and sufficient interlaminar peel strength is difficult to obtain. With the use of the aforementioned 2) rubber rolls alone, there arises a problem of limited means for heating the film during pressing: that is, when rubber rolls are used, the atmospheric temperature is used to control the heating of the film or the rolls and the film breaks easily in the atmosphere so that a stable operation becomes difficult to maintain. A combination of a rubber roll and a metal roll is conceivable and, in this case, the film is heated by one of the pair or the metal roll. However, the temperature of the film cannot be raised sufficiently when the heat resistance of the rubber roll is low and, besides, the temperature of the rubber roll is difficult to control. As a result, sufficient adhesive strength develops with difficulty between the film and metal foil and a laminate produced by the use of rubber rolls has not been qualified for use in substrates for printed circuits where the prime requirement is the adhesive strength between the film and the metal foil. With the use of the aforementioned 3) resin-coated metal rolls in which the thickness of resin coating is normally 10 mm or so, there arises a problem that the surface temperature of the rolls cannot be raised sufficiently as the difference in temperature becomes large between the roll beneath the layer of resin coating and the surface of the layer of resin coating.

With the use of a double belt press, the apparatus is costly and large in size and the maintenance of the belt and other parts in the apparatus becomes difficult.

### DISCLOSURE OF THE INVENTION

An object of this invention is to provide a method for producing a laminate which has good appearance and sufficient adhesive strength between a liquid crystal polymer film and a metal foil and, more particularly, to provide a method for producing a laminate which can be advantageously used in substrates for printed circuits.

The inventors of this invention have found the importance of preventing at least one surface of a laminate of a liquid crystal polymer film and a metal foil from directly contacting the surface of metal rolls and found further that, to accomplish this object, it is effective to coat the surface of at least one of metal rolls with a resin or to interpose a heat-resistant film between at least one surface of a laminate and a metal roll.

This invention relates to a method for producing a laminate from a film of a liquid crystal polymer forming an optically anisotropic molten phase and a metal foil by piling one upon another and bonding them under heat between pressing rolls and the method comprises a) using pressing rolls at least one of which is a metal roll coated with a resin to a thickness of 0.02-5 mm or b) piling a heat-resistant film on the surface of the pile of a liquid crystal polymer film on a metal foil which contacts a metal pressing roll and passing them together between metal pressing rolls.

A liquid crystal polymer film to be used in the production of a laminate according to this invention is made from a liquid crystal polymer which forms an optically anisotropic molten phase. A liquid crystal polymer is also called a thermotropic liquid crystal polymer. A liquid crystal polymer transmits polarized light when its molten specimen is observed under a polarizing microscope equipped with a heating device with the Nicols crossed.

The raw materials for liquid crystal polymers to be used in this invention are not limited and include the following compounds, classified into groups (1) to (4), and their derivatives.

(1) Aromatic or aliphatic dihydroxy compounds.

(2) Aromatic or aliphatic dicarboxylic acids.

(3) Aromatic hydroxycarboxylic acids.

(4) Aromatic diamines, aromatic hydroxyamines and aromatic aminocarboxylic acids.

The liquid crystal polymers derived from the aforementioned compounds include publicly known thermotropic liquid crystal polyesters and polyesteramides. However, it is to be noted that there is a suitable range in combining the raw material compounds to form liquid crystal polymers.

Typical examples of liquid crystal polymers obtained from these raw material compounds are copolymers containing the structural units represented by the following formulas.

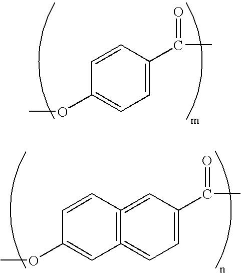

A liquid crystal polymer film useful for this invention is the one whose transition temperature to the optically anisotropic molten phase is in the range of 200-400° C., preferably in the range of 250-350° C., from the viewpoint of heat resistance and processability. It is allowable to incorporate lubricants, antioxidants, fillers and the like to the extent that is not harmful to the properties of a film.

A liquid crystal polymer film can be made, for example, by extrusion molding. Any of the methods used for extrusion molding is applicable and, commercially, T-die extrusion, laminate orientation and inflation are used advantageously. Inflation and laminate orientation are particularly advantageous in that stress is added to a film not only in the machine direction (MD) but also in the transverse direction (TD) and a film with its mechanical properties well balanced in MD and TD is obtained.

The thickness of a liquid crystal polymer film is 500 μm or less, preferably 10-500 μm, more preferably 15-250 μm. When the thickness exceeds 500 μm, a film becomes rigid and difficult to handle, for example, a film becomes difficult to put into the form of a roll. When the thickness is under 10 μm, a film tears easily and becomes difficult to handle.

The material for a metal foil to be used in this invention is not limited and gold, silver, copper, stainless steel, nickel, aluminum and alloys thereof may be cited as examples. Preferred metal foils are those of copper (including alloys containing copper as the main component) and stainless steel. Both rolled and electrodeposited copper foils can be used. To secure good adhesion to a liquid crystal polymer film, the surface of a copper foil may be treated physically or chemically by such means as surface roughening and acid washing to the extent that does not damage the effect of this invention.

The thickness of a metal foil is in the range of 5-150 μm, preferably 10-70 μm, more preferably 10-35 μm. Reducing the thickness of a metal foil is desirable for fine patterning. However, when the thickness is reduced too much, a metal foil wrinkles during the manufacturing step. Furthermore, when a substrate made from an excessively thin metal foil is used in the formation of a circuit, there may occur breakage of wiring or loss of substrate reliability. On the other hand, when the thickness becomes more than adequate, tapering occurs on the edge of a circuit during etching of the metal foil, which is disadvantageous for fine patterning.

According to this invention, a liquid crystal polymer film is piled on a metal foil and, simultaneously with or after the piling, the film and the foil are passed between pressing rolls. From the standpoint of productivity, both liquid crystal polymer film and metal foil are preferably in the form of a roll. A process of high productivity can be realized by having rolls of liquid crystal polymer film and copper foil on hand, transporting them roll to roll continuously and hot-pressing them during transportation. Thermocompression bonding of the rolls of liquid crystal polymer film and metal foil takes place between pressing rolls and, normally, a pair of pressing rolls are used here.

The direct contact of at least one surface of a laminate of a liquid crystal polymer film and a metal foil with the surface of metal rolls is prevented according to this invention and, to accomplish this object, a) the surface of at least one metal roll is coated with a resin or b) a heat-resistant film is interposed between at least one surface of a laminate and a metal roll.

The case of a) where the surface of at least one metal roll is coated with a resin is described first.

A pair of pressing rolls are used and at least one of the pair is a metal roll having on its surface a layer of resin coating with a thickness of 0.02-5 mm. The other one of the pair is suitably a rubber roll, a metal roll or a resin-coated metal roll and it is preferably a resin-coated metal roll whose layer of resin coating has a thickness in the same range as above for the purpose of developing sufficient adhesion between a liquid crystal polymer film and a metal foil. By using a pair of resin-coated metal rolls in this manner, a laminate can be produced from a liquid crystal polymer film and a metal foil with good adhesion even when the thickness of the resin coating on the surface of the metal rolls is reduced.

The metal roll beneath the layer of resin coating is heated by a suitable means. For example, it is desirable to use metal rolls equipped with a heating mechanism such as dielectric heating and circulation of heating medium from the standpoint of securing uniformity in surface temperature. The aforementioned layer of resin coating preferably contains rubber and, concretely, a heat-resistant elastic material such as fluororubber, silicone rubber and polymide is used for the coating. According to this invention, thermocompression bonding of a metal foil to a liquid crystal polymer film is normally performed at a temperature lower than the melting point of the liquid crystal polymer by 20-60° C. and, in consequence, the heat resistance in this temperature range is required for the layer of resin coating.

The thickness of the layer of resin coating on the surface of the metal rolls is required to be in the range of 0.02-5 mm. When the thickness exceeds 5 mm, the difference in temperature between the surface and inside of the metal roll becomes large and this makes the temperature control difficult to exercise in order to realize the condition suitable for the production of a laminate. Moreover, it sometimes becomes difficult to raise the surface temperature of the rolls because of the restriction imposed on the heat resistance of the layer of coating. On the other hand, when the thickness is under 0.02 mm, it becomes difficult to apply uniform pressure which relies on the elastic effect of the layer of resin coating. In order to obtain a laminate with improved shape and interlaminar peel strength, the thickness of the layer of resin coating is controlled in the range of 0.02-2 mm, preferably 0.05-2 mm. According to this invention, the layer of resin coating may be a single layer or a multilayer constructed of plural materials. Even in the case of a multilayer, the thickness of the layer of resin coating needs to be controlled in the aforementioned range or in the preferred range of thickness.

The hardness of the layer of resin coating required for uniform application of pressure is preferably in the range of 60-95 as spring hardness (JIS-A hardness) determined in accordance with JIS K6301 for the type A spring type hardness testing.

Next, the case of b) where a heat-resistant film is interposed between at least one surface of a laminate and a metal roll is described.

A liquid crystal polymer film is piled on a metal foil and, simultaneously with or after the piling and before the passage between pressing rolls, a heat-resistant film is piled on the side which contacts a pressing roll. That is, a heat-resistant film is piled on at least one side, preferably both sides, of the pile of a liquid crystal polymer film on a metal foil to prevent a liquid crystal polymer film or a metal foil or both from directly contacting pressing rolls.

Thermocompression bonding of a liquid crystal polymer and a metal foil occurs between pressing rolls and normally a pair of metal pressing rolls are used. A heat-resistant resin film or a heat-resistant resin composite film is used as a heat-resistant film to be passed together with a metal foil and a liquid crystal polymer film during pressing. Films of resins such as polyimides, polyamideimides, aromatic polyamides, polyphenylene sulfide, polyethylene naphthalate, fluoropolymers and liquid crystal polymers are useful as heat-resistant films. The composites of these resins with metals, other resins, (inorganic) fibers and the like provide heat-resistant resin composite films. Concrete examples are a composite of polyimide or liquid crystal polymer and copper and a composite of fluoropolymer and aramid fibers.

An efficient process for producing a laminate of good appearance requires a non-adhesive heat-resistant film which does not adhere to metal pressing rolls or to a laminate being formed there when the pressing rolls are operated at a surface temperature of 250° C. and a pressure of 150 kN/m. The thickness of a heat-resistant film is in the range of 25-300 μm, preferably 50-250 μm, more preferably 75-240 μm. When the thickness is reduced too much, a metal foil may wrinkle in the course of production and, when a substrate made from an excessively thin film is used in the formation of a circuit, there may occur breakage of wiring or loss of substrate reliability. On the other hand, when the thickness increases more than adequate, the difference in temperature between the surface of the rolls and the raw materials consisting of a metal foil and a liquid crystal polymer film becomes large, which lowers the adhesive strength of a laminate.

The tensile modulus of a heat-resistant film is in the range of 1-30 GPa, preferably 1-15 GPa, more preferably 1-10 GPa. As the tensile modulus increases above this range, a metal foil tends to wrinkle easily in the production step. On the other hand, when the tensile modulus decreases below this range, films tend to deform and may adversely affect the appearance of a laminate.

A laminate is produced from a liquid crystal polymer film and a metal foil by passing the two together with a heat-resistant film between metal pressing rolls. The heat-resistant film is peeled from the laminate immediately after the passage between metal pressing rolls or after several production steps. Therefore, the heat-resistant film should not adhere to the metal pressing rolls and, besides, it should not adhere so strongly to the laminate as to resist peeling. For this reason, a heat-resistant film with an adequate melting point that behaves this way is used. That is, the heat-resistant film selected for use is required to have a melting point higher than the surface temperature of metal pressing rolls and remain smooth without deformation when submitted to heat and a pressure of 150 kN/m. Thus, it is preferable to use a film made from a material with a melting point above 250° C., for example, a composite material based on polyimide or fluoropolymer.

In either of the cases a) and b) described above, the surface of metal pressing rolls should be heated by a suitable means. The means for heating are not limited and dielectric heating or circulation of heating medium may be cited as an example. Metal rolls are used in this invention and it is convenient to provide a heating mechanism inside the metal rolls and heat the surface of rolls as well. The surface temperature of rolls is kept at a point below the melting point of a liquid crystal polymer film by 5-100° C., preferably by 20-60° C. A liquid crystal polymer film may not bond sufficiently strongly to a metal foil when the surface temperature of heating rolls is low. As the surface temperature of heating rolls approaches the melting point of said film, the film flows considerably during thermocompression bonding and yields a laminate of poor appearance.

The aforementioned melting point of a liquid crystal polymer film means the peak melting point when a film to be submitted to thermocompression bonding is tested at a rate of temperature rise of 10° C./min by differential scanning calorimetry (DSC).

The pressure during thermocompression bonding is not limited as long as it is in the range suitable for uniform application of pressure in the width direction and it is preferably in the range of 5-200 kN/m, more preferably 10-40 kN/m.

The laminates produced according to this invention are not limited to the one with a two-layer structure consisting of a liquid crystal polymer film and a metal foil. That is, the laminates comprise at least one layer of liquid crystal polymer and at least one layer of metal foil and may have a three-layer structure shown in I) to V), a four-layer structure shown in IV) and a five-layer structure shown in V) below:

I) metal foil/film/metal foil,

II) film/film/metal foil,

III) film/metal foil/film,

IV) metal foil/film/film/metal foil, and

V) metal foil/film/metal foil/film/metal foil.

Furthermore, it is possible to perform bonding of a film and a metal foil simultaneously at two or more interfaces according to this invention; for example, a film is sandwiched between metal foils and compression-bonded to give a laminate of a three-layer structure or metal foil/film/metal foil.

The laminates obtained according to the method of this invention have a good form, retain excellent mechanical strength, electrical properties and heat resistance inherent in liquid crystal polymers and show good adhesion of the film to the metal foil not only at room temperature but also at high temperatures and they are useful as materials for producing the tapes for flexible printed circuits (FPC) and tape automated bonding (TAB).

### PREFERRED EMBODIMENTS OF THE INVENTION

This invention is described concretely below with reference to the accompanying examples, but it is in no way limited to these examples.

The laminates obtained in the examples and comparative examples were evaluated in accordance with the methods described below.

(1) Appearance

Appearance 1: A laminate produced by compression-bonding a liquid crystal polymer film to a metal foil was observed visually to examine whether the film deformed or not and its appearance was judged good when the film did not deform or poor when the film deformed.

Appearance 2: A laminate produced by compression-bonding a liquid crystal polymer film to a metal foil was observed visually and evaluated as follows:

⊚ None of wrinkles, streaks and deformation observed,

◯ Either of wrinkles, streaks and deformation observed slightly,

x Either of wrinkles, streaks and deformation observed.

(2) Interlaminar peel strength: It was determined by submitting a metal foil with a width of 1 mm to a 180-degree peel test at room temperature.

(3) Solder heat resistance: A laminate whose metal foils were patterned on both sides in circles with a diameter of 1 mm was immersed in a solder bath at 260° C. and then observed for the presence or absence of deformation. The heat resistance was judged good when there was no change in the appearance before and after the immersion and judged poor when blistering, peeling and the like were observed.

The following liquid crystal polymer film and copper foil were used in the examples and comparative examples.

Liquid crystal polymer film: Vecstar (trade name); melting point, 280° C.; thickness, 50 μm.

Copper foil: electrodeposited; thickness, 18 μm.

### EXAMPLES 1-3

A copper foil was piled on both sides of a liquid crystal polymer film and immediately supplied to a pair of pressing rolls continuously at a rate of 1 m/min. The pair of pressing rolls consisted of two metal rolls coated uniformly with fluororubber to a thickness of 1 mm and the surface of the rolls was heated at a prescribed temperature by a heating mechanism installed inside the metal rolls. The raw material film and foil were in the form of a roll and a laminate was produced continuously by the roll-to-roll method wherein thermocompression bonding was effected in the intermediate step.

The surface temperature of the resin coating on the pressing rolls and the results of evaluation of the laminates produced are shown in Table 1.

### EXAMPLES 4-5

Laminates were produced as in Example 1 with the exception of using a pair of pressing rolls consisting of metal rolls coated with silicone rubber to a thickness of 3 mm.

### EXAMPLE 6

A laminate was produced as in Example 1 with the exception of using a pair of pressing rolls consisting of metal rolls coated with polyimide to a thickness of 25 μm

### COMPARATIVE EXAMPLES 1-3

Laminates were produced as in Example 1 with the exception of using a pair of pressing rolls consisting of uncoated metal rolls.

### COMPARATIVE EXAMPLE 4

A laminate was produced as in Example 1 with the exception of using a pair of pressing rolls consisting of metal rolls coated with fluororubber to a thickness of 10 mm. It was not possible to raise the surface temperature of the fluororubber coating on the pressing rolls above 210° C.

The surface temperature of the layer of resin coating on the pressing rolls and the results of evaluation of the laminates produced are shown in Table 1.

TABLE 1

| | Surface | | Interlaminar | Solder |
|---|---|---|---|---|
| | temperature | | peel strength | heat |
| | (° C.) | Appearance 1 | (N/mm) | resistance |
| Example 1 | 230 | Good | 1.1 | Good |
| Example 2 | 250 | Good | 1.5 | Good |
| Example 3 | 255 | Good | 1.4 | Good |
| Example 4 | 230 | Good | 1.2 | Good |
| Example 5 | 250 | Good | 1.4 | Good |
| Example 6 | 230 | Good | 1.3 | Good |
| Comp. Ex. 1 | 230 | Good | 1.5 | Poor |
| Comp. Ex. 2 | 240 | Good | 1.4 | Poor |
| Comp. Ex. 3 | 250 | Poor | — | — |
| Comp. Ex. 4 | 210 | Good | 0.6 | Poor |

### EXAMPLES 7-9

A copper foil (B) was piled on both sides of a liquid crystal polymer film (A), a polyimide film (C) with a thickness of 75 μm was further piled to form a layered structure of C/B/A/B/C and the pile was supplied continuously at a rate of 1 m/min to a pair of metal pressing rolls with a diameter of 250 mm whose surface had been heated at the temperature shown in Table 2 while applying a pressure of 150 kN/m. Thereafter, the polyimide film (C) was peeled off to give a laminate. The liquid crystal polymer film, copper foil and polyimide film were in the form of a roll. The surface temperature of the metal pressing rolls and the results of evaluation of the laminates produced are shown in Table 2.

### EXAMPLES 10-12

Laminates were produced as in Examples 7-9 with the exception of using a film of fluoropolymer containing aramid fibers (D) with a thickness of 230 μm in place of the polyimide film (C) or using a layered structure of D/B/A/B/D.

### COMPARATIVE EXAMPLES 5-7

A copper foil was piled on both sides of a liquid crystal polymer film and supplied at a rate of 1 m/min to metal pressing rolls with a diameter of 250 mm whose surface had been heated at a prescribed temperature while applying a pressure of 150 kN/m.

### COMPARATIVE EXAMPLE 8

A copper foil was piled on one side of a liquid crystal polymer film and supplied at a rate of 1 m/min to metal pressing rolls with a diameter of 250 mm whose surface had been heated at a prescribed temperature while applying a pressure of 150 kN/m.

The surface temperature of the heating rolls and the results of the evaluation of the laminates produced are shown in Table 2.

TABLE 2

| | Surface | | Interlaminar |
|---|---|---|---|
| | temperature | | peel strength |
| | (° C.) | Appearance 2 | (N/mm) |
| Example 7 | 210 | ◯ | 0.8 |
| Example 8 | 220 | ◯ | 0.9 |
| Example 9 | 230 | ◯ | 1.0 |
| Example 10 | 210 | ⊚ | 0.9 |
| Example 11 | 220 | ⊚ | 0.9 |
| Example 12 | 230 | ⊚ | 1.0 |
| Comp. Ex. 5 | 210 | X | — |
| Comp. Ex. 6 | 220 | X | — |
| Comp. Ex. 7 | 230 | X | — |
| Comp. Ex. 8 | 210 | X | — |

### INDUSTRIAL APPLICABILITY

A heat-resistant laminate can be produced from a liquid crystal polymer film and a metal foil with sufficient adhesive strength at high productivity according to this invention. The laminate is characterized by retaining excellent properties inherent in the liquid crystal polymer in respect to heat resistance, dimensional stability against moisture and high frequency characteristics and exhibiting good adhesion of the liquid crystal polymer film to the metal foil and is useful as a substrate for circuits, typically, flexible circuits.

1. A method for producing a laminate by piling a film of a liquid crystal polymer forming an optically anisotropic molten phase on a metal foil and passing the pile between pressing rolls to effect compression bonding of said film and metal foil which comprises using a metal roll provided on its surface with a layer of resin coating having a thickness of 0.02-5 mm as at least one of said pressing rolls.

2. A method for producing a laminate as described in claim 1 wherein said pressing rolls consist of a pair of rolls either of which is a metal roll provided on its surface with a layer of resin coating having a thickness of 0.02-2 mm.

3. A method for producing a laminate as described in claim 1 wherein the surface temperature of said rolls during compression bonding is controlled at a point lower than the melting point of the liquid crystal polymer film by 20-60° C.

4. A method for producing a laminate by piling a film of a liquid crystal polymer forming an optically anisotropic molten phase on a metal foil and passing the pile between metal pressing rolls to effect compression bonding of said film and metal foil which comprises further piling a heat-resistant film selected from heat-resistant resin films and heat-resistant resin composite films on the surface of said pile of the liquid crystal polymer film and metal foil contacting a metal pressing roll and passing the resulting pile between metal pressing rolls.

5. A method for producing a laminate as described in claim 4 wherein the thickness of the heat-resistant film is 25-300 μm.

6. A method for producing a laminate as described in claim 4 or 5 wherein the tensile modulus of the heat-resistant film is 1-30 GPa.

7. A method for producing a laminate as described in claim 4 wherein the heat-resistant film does not adhere to the metal pressing rolls when the surface temperature of the metal pressing rolls is 250° C. and the pressure applied is 150 kN/m.
